(19) United States
(12) Patent Application Publication
(10) Pub. No.: US 2024/0338572 A1
(43) Pub. Date: Oct. 10, 2024

(54) System and Methods for Training Machine-Learned Models for Use in Computing Environments with Limited Resources

(71) Applicant: Google LLC, Mountain View, CA (US)

(72) Inventors: Nicholas Gillian, Palo Alto, CA (US); Lawrence Au, Sunnyvale, CA (US)

(21) Appl. No.: 18/681,763

(22) PCT Filed: Aug. 6, 2021
(86) PCT No.: PCT/US2021/044995

§ 371 Date: Feb. 6, 2024

(51) Int. Cl. G06N 3/096; G06N 3/0455

(52) U.S. Cl. CPC G06N 3/096; G06N 3/0455

(57) ABSTRACT

The present disclosure provides computer-implemented methods, systems, and devices for efficient training of models for use in embedded systems. A model training system accesses unlabeled data elements. The model training system trains one or more encoder models for data encoding of using each unlabeled data element as input. The model training system generates an encoded version of each of a plurality of labeled data elements. The model training system trains decoder models for label generation using the encoded version of the second data set as input. The model training system generates provisional labels for the unlabeled data elements in the first data set, such that each unlabeled data element has an associated provisional label. The model training system trains one or more student models using the unlabeled data elements from the first data set and the associated provisional labels.

### FIELD

The present disclosure relates generally to machine-learned models for use in embedded systems.

### BACKGROUND

As computer technology has increased, machine-learned computer models have been used to solve increasingly complicated problems. However, generally, the most powerful and accurate models require significant amounts of memory and computing power to achieve the most accurate results. As such, limited computer environments such as embedded devices have not been able to benefit fully from advances in machine-learning technology.

### SUMMARY

Aspects and advantages of embodiments of the present disclosure will be set forth in part in the following description, or may be learned from the description, or may be learned through practice of the embodiments.

One example aspect of the present disclosure is directed to a computer-implemented method of training student models. The method includes accessing, by a computing system including one or more processors, a first data set, the first data set comprising a plurality of unlabeled data elements. The method includes training, by the computing system, one or more machine-learned encoder models for data encoding using each unlabeled data element in the first data set as input. The method includes generating, by the computing system using the one or more machine-learned encoder models, an encoded version of each of a plurality of labeled data elements of a second data set. The method includes training, by the computing system, a plurality of machine-learned decoder models for task-specific label generation using the encoded version of each of the plurality of labeled data elements of the second data set as input. The method includes generating, by the computing system using the one or more machine-learned encoder models and the plurality of machine-learned decoder models, a plurality of associated provisional labels for the plurality of unlabeled data elements in the first data set, such that each unlabeled data element has an associated provisional label. The method includes training, by the computing system, one or more student models using the plurality of unlabeled data elements from the first data set and the plurality of associated provisional labels. The method includes deploying, by the computing system, the one or more student models onto one or more embedded computing devices.

Another example of the present disclosure is directed towards a model training computing system. The model train computing system comprises memory and a processor communicatively coupled to the memory, wherein the processor executes application code instructions that are stored in the memory to cause the system to access a first data set, the first data set comprising a plurality of unlabeled data elements. The instructions further cause the system to train one or more machine-learned encoder models for data encoding of using each unlabeled data element in the first data set as input. The instructions further cause the system to generate, using the one or more machine-learned encoder models, an encoded version of each of a plurality of labeled data elements of a second data set. The instructions further cause the system to train a plurality of machine-learned decoder models for task-specific label generation using the encoded version of each of the plurality of labeled data elements of the second data set as input. The instructions further cause the system to generate, using the one or more machine-learned encoder models and the plurality machine-learned decoder models, a plurality of associated provisional labels for the plurality of unlabeled data elements in the first data set, such that each unlabeled data element has an associated provisional label. The instructions further cause the system to train one or more student models using the plurality of unlabeled data elements from the first data set and the plurality of associated provisional labels. The instructions further cause the system to deploy the one or more student models onto one or more embedded computing devices.

Another example of the present disclosure is directed towards an embedded computing device. The embedded computing device comprises a computing storage device storing a small machine learned model. The embedded computing device comprises one or more processors configured to execute the small machine-learned model to perform a designated task. The small machine-learned model is trained by accessing, by a model training system including one or more processors, a first data set, the first data set comprising a plurality of unlabeled data elements. The small machine-learned model is further trained by training, by the model training system, one or more machine-learned encoder models for data encoding of using each unlabeled data element in the first data set as input. The small machine-learned model is further trained by generating, by the model training system using the one or more machine-learned encoder models, an encoded version of each of a plurality of labeled data elements of a second data set. The small machine-learned model is further trained by training, by the model training system, a plurality of machine-learned decoder models for task-specific label generation using the encoded version of each of the plurality of labeled data elements of the second data set as input. The small machine-learned model is further trained by generating, by the model training system using the one or more machine-learned encoder models and the plurality machine-learned decoder models, a plurality of associated provisional labels for the plurality of unlabeled data elements in the first data set, such that each unlabeled data element has an associated provisional label. The small machine-learned model is further trained by training, by the model training system, one or more student models using the plurality of unlabeled data elements from the first data set and the plurality of associated provisional labels. The small machine-learned model is further trained by deploying, by the model training system, the one or more student models onto one or more embedded computing devices.

Other example aspects of the present disclosure are directed to systems, apparatus, computer program products (such as tangible, non-transitory computer-readable media but also such as software which is downloadable over a communications network without necessarily being stored in non-transitory form), user interfaces, memory devices, and electronic devices for implementing and utilizing machine learned models in embedded systems.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which refers to the appended figures, in which:

FIG. 1 illustrates an example computing environment including a model training system in accordance with example embodiments of the present disclosure;

FIG. 2 illustrates an example computing environment including a model training system in accordance with example embodiments of the present disclosure:

FIG. 3 illustrates an example computing environment including a model training system in accordance with example embodiments of the present disclosure;

FIG. 4A is a graph depicting the accuracy of machine-learned models with respect to the number of parameters used by a teacher model in accordance with example embodiments of the present disclosure:

FIG. 4B is a graph depicting the accuracy of machine-learned models with respect to the number of parameters used by a teacher model in accordance with example embodiments of the present disclosure:

FIG. 5A is a graph depicting the accuracy of student machine-learned models based on the number of teacher machine-learned models in accordance with example embodiments of the present disclosure:

FIG. 5B is a graph depicting the variance in student machine-learned models based on the number of teacher machine-learned models in accordance with example embodiments of the present disclosure:

FIG. 6A is a graph depicting the accuracy of machine-learned models based on the number of available examples in accordance with example embodiments of the present disclosure:

FIG. 6B is a graph depicting the accuracy of machine-learned models based on the length of the unlabeled dataset length in accordance with example embodiments of the present disclosure:

FIG. 7 is a graph depicting the accuracy of machine-learned models based on the number of parameters in the student models in accordance with example embodiments of the present disclosure:

FIG. 8 depicts a block diagram of an example teacher machine-learned model according to example embodiments of the present disclosure:

FIG. 9 depicts a block diagram of an example student machine-learned model according to example embodiments of the present disclosure; and

FIG. 10 is a flowchart depicting an example process of training an efficient computing-learned model for use on an embedded computing device in accordance with example embodiments of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally, the present disclosure is directed towards a semi-supervised teacher-student framework for using large unlabeled data sets to train efficient machine-learning models. By way of example, the semi-supervised teacher-student framework may be used to train small machine-learned models for use on embedded microcontrollers. To do so, the framework is implemented by a model training system. The model training system can access a large unlabeled dataset, including a plurality of data elements (or a sequential stream of data). Labels can be any data that provides classifies the data elements into a particular group or identifies important features based on a specific task. For example, if the task is to identify animals in an image, the labels can be data describing which animals are in a particular image. Labels can be incorporated into or appended to the data element at the time of labeling. Alternatively, label data can be stored separately (e.g., in a database that references the label data for each particular element). If a particular data elements is used for training multiple models for multiple different tasks, each task can have a separate label containing the classification that is relevant to the associated task.

Labeling each data element in the dataset would be time consuming and expensive. Instead, the model training system can initialize one or more encoder models (e.g., a model implementing a neural network), wherein the encoder models use data elements without labels as input and output an encoded version of the data elements. As the model is trained, the output of the model can be evaluated based on a task agnostic evaluation metric (e.g., a clustering algorithm can provide feedback without specifying a specific task) and the parameter values (e.g., node weights) can be adjusted based on the evaluation metric.

Once the one or more encoder models have been trained, the model training system can use labeled data (e.g., wherein the labels are associated with a particular task) to train a plurality of decoder models. A decoder model can use the encoded data generated by the one or more encoder models as input and output a label for the encoded data element, wherein the label is associated with a specific task.

In some examples, each decoder model is paired with a different encoder model, to form a teacher model that takes data elements as input and outputs labels associated with a specific task. The labels generated by the decoder models can be provisional labels or soft labels. These provisional labels or soft labels can be distinguished from labels generated by humans which can sometimes be called hard labels. In some examples, hard labels can be represented with one-hot encoding. One-hot encoding can mean that if a plurality of categories are possible for a given data element, only one of them is designated as true (or hot). Thus, if the categories are represented as a series of values set to either 1 (representing that the data element is included in the category) or 0 (representing that the data element is not included in the category), one-hot encoding ensures that only one value is set to 1. One-hot encoding can be used when the confidence when assigned categories is very high (e.g., when performed by a qualified human).

Provisional labels (or “soft labels) differ from non-provisional or hard labels in that, because they are generated by a model rather than a human, they have associated confidence levels. The confidence levels can represent the degree to which the model is confident that the provisional label is accurate. Like label data, confidence label data associated with particular provisional labels can be included in or appended to the data element. Alternatively, the provisional label data and the associated confidence values can be stored in an associated database that links each provisional label (and its associated confidence values) to a particular data element.

Once soft labels have been generated for each data element in the large unlabeled data set, the model training system can train a plurality of small student models. In this case, small models have significantly fewer parameters than the encoder models and the decoder models. For example, the encoder models and decoder models combined may have a number of parameters that exceeds one million parameters, while the smaller student models may have a number of parameters less than 10,000. Thus, the smaller student models require significantly less data storage and less computing processing power for performing classifying tasks. For this reason, the smaller student models can be used in computing systems with constrained storage space (e.g., computer memory) and processing power, such as an embedded system.

The tiny student models (e.g., tiny ML model) can be trained by using the large unlabeled data set as input. Using its initial parameter values, the student model can generate a classification for each data element in a large data set. The values of the parameters (e.g., weights) can be adjusted based on the comparison between the classification generated by the student model and the provisional labels generated by the teacher models (e.g., a plurality of encoder models, each paired with a different decoder model) or the predetermined labels associated with the labeled data elements.

Once the student models have been trained (e.g., to a predetermined accuracy threshold), the student model can be deployed into an appropriate computing system such as an embedded computing device in a wearable computing device. Then the embedded device can receive input (e.g., data sensed by the computing system) and the student model can appropriately classify the data to perform the task for which it was trained.

For example, the student model can be trained to perform simple voice recognition tasks. The student model can be implemented in an embedded computing device in an article of clothing and can be used to classify or categorize detected audio input to determine whether any of the audio input should be interpreted as voice commands from the user.

More specifically, the model training system can be a computing system that includes one or more processors and a storage device. The storage device can store data and instructions that can then be executed by the one or more processors. The model training system can access a dataset (e.g., a plurality of data elements) and use it to train one or more models.

In some examples, the data can include a large number of data elements. The data elements can be any type of data including files, data structures, a portion of a stream of sequential data generated by a sensor, or any other data format accessible to computing devices. In some examples, a very large number of data elements can be used to train a model. However, the process of labeling all the data elements of a large dataset for a particular task can be extremely time consuming and inefficient. To overcome this problem, the model training system can use unlabeled data to train its machine-learned models.

For example, the model training system can initialize one or more encoder models. The encoder models can include one or more neural networks. A neural network can include an input layer, an output layer, and one or more hidden layers. Each hidden layer can include a plurality of nodes and connections between nodes. Each node and each connection can be assigned a weight. Thus, the parameters of a machine-learned model can include, but are not limited to: the number of layers, the number of nodes, the connections between nodes, the weight of each connection, and the weight of each node. In some examples, a plurality of different encoder models are initialized and trained. In other examples, only one encoder model is initialized and trained. In this case, multiple copies of the one encoder model are paired with a plurality of different decoder models for further training on a specific task to form a plurality of distinct teacher models. For example, five different distinct teacher models can be trained by the model training system for a particular task. In general, the greater the diversity of teacher models, the more effectively and efficiently the system can train one or more student models.

The encoder model can be trained in a task agnostic manner. Because little or no labeled data may be available to train the encoder model, the model training system can be trained in an unsupervised way without a specific task that can be used to evaluate the accuracy of the model. Instead, a task agnostic algorithm (e.g., a clustering algorithm, anomaly detection algorithms, algorithms for learning latent variables such as expectation maximization, and so on) can be used to evaluate the encoded data output by the encoder model while training. For example, if the dataset includes a plurality of images without a particular task to accomplish, the encoded data can represent a grouping of images that are similar based on features detected in those images. The grouping can be evaluated using a clustering algorithm and the parameters of a model can be adjusted such that the model more accurately groups images that are similar (e.g., have similar features).

Thus, to train the encoder model, the model training system can initiate one or more encoder models with initial parameter values (e.g., weights). The model training system can use the unlabeled data set as input to the one or more encoder models. The one or more encoder models can output encoded versions of each data element. Training generally refers to a process in which a model receives input and, based on the parameter values of the model, produces an output. Rather than being used for a particular purpose, this output can be evaluated (e.g., either based on ground truth data for the task the model is intended to perform or using a task agnostic evaluation technique) and the parameters of the model are updated to improve the accuracy of the model when producing the output. The output produced during the training stage is not used to perform the particular task.

The model training system can evaluate the accuracy of the encoded data using one or more unsupervised or self-supervised training algorithms. For example, wav2vec is an example in which a system is trained using a self-supervised algorithm. Wav2vec can be employed in the use of an auxiliary task, where a separate model is trained, which takes an aggregation aᵢ=pₖ (gₖ (xᵢ−l+1), . . . , (gₖ (xᵢ)) of l of past examples xᵢ−l+1, . . . , xᵢ and predicts the embedding representation eᵢ=(gₖ (xᵢ₊ₛ) example s steps into the future. For each step s∈{1 . . . S} the system trains an affine transformation in a form of hₛ(aᵢ)=Wₛaᵢ+bₛ. This prediction is contrasted with the embedding of a real example s steps into the future eᵢ₊ₛ and a set of negative examples \tilde{e} sampled from a distribution q. For a given step s the loss function is as follows:

$${L}_{s} = - {\sum }_{i = 1}^{T - s} ( log σ ( {e}_{i + 1}^{⊤} {h}_{s} ( {a}_{i} ) ) + {λ𝔼}_{\tilde{e}} [ log σ ( - {\tilde{e}}^{⊤} {h}_{s} ( {a}_{i} ) ) ] )$$

where σ is the sigmoid function

$$σ ( x ) = \frac{1}{1 + {e}^{- x}} ,$$

λ is a hyperparameter for weighing in the negative examples. Expected value can be approximated by sampling negative examples λ times. The full loss function can be a sum of loss functions for all steps L=Σₛ^{S}(Lₛ)

In other examples, a clustering algorithm can be used to group data elements used as input to the encoder model into one or more clusters. The grouping can then be evaluated using a cluster evaluation technique and the parameter values of the encoder model can be adjusted based on that evaluation.

In some examples, a second data set of training data can have predetermined labels associated with each data element. These labels may be added by human reviewers prior to the training process and can represent classifications or labels associated with a particular task. In a simple example, if the data set includes images, and the task it to determine the type of animal in each image, the labeled data elements have been reviewed by a human reviewer who determines that animal in the image and attaches that label to the data element. In some examples, the data elements from the second data set can be used as input during the initial pre-training stage of the encoder models by temporarily removing their labels and using them as unlabeled input into the one or more encoder models while the one or more encoder models are being trained.

Once the one or more encoder models have been trained to a predetermined threshold of accuracy, the model training system can initialize a plurality of decoder models. Each decoder model can take as input the encoded data produced by the one or more encoded models and output one or more labels or classifications associated with a particular data element used as input to the encoder model. Once the encoders are initialized (e.g., initial values are associated with their parameters), the model training system can access the second data set of labeled data. As noted above, the labeled data can be labeled in accordance with performing a particular task.

Each decoder model can be paired with a particular encoder model to form an encoder decoder teacher model. If only one encoder model is trained, the model training system can pair each version of the decoder model with a copy of the trained encoder model. However, if a plurality of distinct encoder models were trained each can be paired with a particular decoder model. The encoder decoder teacher models can use unlabeled data elements as input and produce provisional labels for the respective data element as output.

To train the decoder models, data elements associated with the label data are used as input to the encoder decoder teacher model and the decoder can produce a provisional label. That provisional label can be compared to the predetermined category or label and cross entropy teacher loss can be calculated. The parameters of both the decoder model and its associated encoder model can be tuned (or adjusted) to minimize the categorical cross entropy teacher loss as shown below:

$${L}^{{T}_{k}} = - {\sum }_{i}^{\vert \hat{D} \vert} {\sum }_{j}^{\vert y \vert} {y}_{j} log {P}^{{T}_{k}} ( {y}_{j} \vert {x}_{i} )$$

where P^{T}^{ₖ}(yⱼ|xᵢ) is the k′th teacher's probability estimate of the j′th class, given the i′th data example:

$${P}^{{T}_{k}} ( {y}_{j} \vert {x}_{i} ) = \frac{exp ( {f}_{k} ( {g}_{k} ( {x}_{i} ) ) [ {y}_{j} ] / τ )}{{\sum }_{n}^{\vert y \vert} exp ( {f}_{k} ( {g}_{k} ( {x}_{i} ) ) [ {y}_{n} ] / τ )}$$

Here τ represents the temperature parameter commonly used in distillation, where higher values of τ produce a “softer” probability distribution over the respective classes (also called categories or labels).

Thus, the output of the encoder decoder teacher model can include, for each data element, one or more labels. In some examples, the one or more labels can each have an associated confidence or weight representing the likelihood that the data element should have that label. For example, if the data element is an image and the labels represent animals that appear in the image, a particular image could have the labels lion and jaguar with lion having a confidence value of 70% and jaguar having a confidence value of 30%. Every unlabeled data element in the first data set can be associated with one or more provisional labels outputted by the plurality of encoder decoder teacher models. Thus, if there are five total encoder decoder teacher models, each one can produce its own provisional labels.

In some examples, the provisional labels generated by each of the plurality of encoder decoder teacher models can be combined together into an aggregated provisional label. The aggregated provisional label can represent an average estimation of the correct label for a particular data element. In another example, aggregated provisional labels can include all information generated by each of the encoder decoder teacher models for use when training the student models.

The model training system can then initialize one or more student models. As noted above, the student models can include significantly fewer parameters (e.g., weights of nodes and other data used to describe and define the model) than either the encoder models or the decoder models. For example, the encoder models can include a very large set of parameters (e.g., over 1,000,000 parameters). In contrast, the student models can include orders of magnitude fewer parameters (e.g., less than 10000). Because the student models have significantly fewer parameters, they require less space to store and less processing power to execute. In this way, the student models, once trained, can be used in computing systems with limited storage capacity and/or limited processing power such as an embedded computing system.

While being trained the student models can receive data elements from the first data set as input and generate labels as output. The parameters (e.g., weights) of the one or more student models can be adjusted based on a comparison between the label generated by the student model and the provisional labels (or aggregated provisional label) generated by the encoding decoding teacher models.

For example, the model training system can measure the student ensemble loss over the full complement of the training data D such that the loss can be represented as:

$${L}^{TS} = - {\sum }_{i}^{\vert D \vert} {\sum }_{j}^{\vert y \vert} log {P}^{S} ( {y}_{j} \vert {x}_{i} ) \frac{1}{K} {\sum }_{k}^{K} {P}^{{T}_{k}} ( {y}_{j} \vert {x}_{i} )$$

wherein P^{T}^{_{K}}(yⱼ|xᵢ) is the provisional label emitted by the K′th teacher model in the plurality of teacher models and P^{S}(yⱼ|xᵢ) is the student's estimation of the jth label probability for the ith data element.

$${P}^{S} ( {y}_{j} \vert {x}_{i} ) = \frac{exp ( {f}_{S} ( {x}_{i} ) [ {y}_{j} ] / τ )}{{\sum }_{n = 1}^{\vert y \vert} exp ( {f}_{S} ( {x}_{i} ) [ {y}_{n} ] / τ )}$$

where f_{S}(xᵢ) is the prediction from the student.

Once the student models have been trained using the provisionally labeled data, the student models can classify new unlabeled data elements received with significantly fewer parameters than are required for the teacher models. The provisional labels provided by the plurality of encoder decoder teacher models enable the student models to be trained to accurately classify unlabeled data elements with a fraction of the resources used by the encoder decoder teacher models.

Once trained, the student models can be deployed to or otherwise exported to embedding computing devices where they will perform the task for which they were trained. For example, the embedded device may have one or more sensors that produce signals detected from its environment. The signals can be used as input to the student model on the embedded computing device and the student model can produce, as output, a label or classification for the detected signal.

In one example, the embedded computing device can be included in an article of clothing and the sensors can detect movements. For example, an accelerometer can be used to detect acceleration, a gyroscope to detect other movements, and so on. These sensors can produce data representing the movement of the article of clothing and that data can be input into the student model. The student model can classify the movements to determine whether any of the movements are intended as input to a device by the user. For example, if the embedded computing device is included in a glove to allow the user to easily navigate a web page, certain gestures such as swiping left or right or swiping up or down may be associated with moving information on the screen (e.g., scrolling a web page up or down). The student model can classify movement based on the sensor data produced by the sensors to determine whether any of the movements match a gesture associated with a predetermined command. If so, the command can be implemented by the computing device.

The following provides an end-to-end example of the technology described herein. A model training system can include memory and one or more processors to execute instructions stored in the memory. The model training system can access, by a computing system including one or more processors, a first data set, the first data set comprising a plurality of unlabeled data elements. Data elements can be files, data structures, sequential time series data captured by sensors and sub-divided into a plurality of time periods, or any other format for storing digital data.

The model training system can train one or more machine-learned encoder models to generate an encoded version of each data element in the first data set. Each model described herein (e.g. encoder models, decoder models, teacher models, and student models) can have an associated plurality of parameters. Used generally, the parameters associated with a model include the data that describes the characteristics of the model, including but not limited to the weights assigned to the connections between each node of a neural network (e.g. for models that use a neural network).

In some examples, the one or more machine-learned encoder models can be trained to be task agnostic. The machine-learned encoder model can be trained using an unsupervised training technique. In this way, the one or more machine-learned encoder models can be used for multiple different tasks. More specifically, once a task-agnostic encoder model has been trained, it can be replicated for use with a plurality of different task-specific decoders, significantly reducing the amount of time and power needed to train task-specific models.

Training the one or more machine-learned encoder models to generate an encoded version of each data element in the first data set can include, for a respective machine-learned encoder model in the one or more machine-learned encoder models, initializing values for a plurality of parameters associated with the respective machine-learned encoder model. In some examples, the initial values are randomly chosen (or pseudo-randomly). In other examples, the initial values can be based on a preexisting model (e.g., a model developed for a similar task in the past).

The model training system can generate, using the respective machine-learned encoder model, encoded data for a plurality of data elements in the first data set. The modeling training system can evaluate the encoded data using a task-agnostic algorithm. In some examples, the task-agnostic algorithm is a clustering algorithm that determines whether the encoded data generated by the one or more machine-learned encoder models are grouped appropriately. In some examples, a particular self-supervised method such as wav2vec can be used.

The model training system can update the values (e.g., weights) for the plurality of parameters associated with the respective machine-learned encoder model based on the evaluation of the encoded data using the task-agnostic algorithm.

The model training system can access a second data set, the second data set comprising a plurality of data elements with associated predetermined labels. In some examples, the number of unlabeled data elements in the first data set (e.g., over one hundred thousand) can exceed the number of labeled data elements in the second data set (e.g., as few as ten).

The model training system can train a plurality of machine-learned decoder models to generate a label for a specific task using the labeled data elements as input. To do so, the modeling training system can, for a respective machine-learned decoder model in the plurality of machine-learned encoder models, initialize values for a plurality of parameters (e.g., node weights) associated with the respective machine-learned decoder model. As noted above, the values can be randomly generated or specifically chosen.

The model training system can generate, using the respective machine-learned decoder model, labels for a plurality of data elements in the second data set. The modeling training system can compare the generated labels with the predetermined labels for the plurality of data elements in the second data set.

The model training system can update the values for the plurality of parameters associated with the respective machine-learned decoder model based on the comparison between the generated labels and the predetermined labels. In some examples, the predetermined labels are domain-specific labels associated with the specific task.

The model training system can, for a respective machine-learned decoder model, combine, by the computing system, the respective machine-learned decoder model with a machine-learned encoder model into an encoder decoder teacher model. The modeling training system can generate, using the encoder decoder teach model, labels for a plurality of data elements in the second data set. The modeling training system can compare the generated labels with the predetermined labels for the plurality of data elements in the second data set. The modeling training system can update parameter values associated with the respective machine-learned decoder model and the machine-learned encoder model included in the encoder decoder teacher model. The combined encoder decoder teacher model can take data elements from the first data set as input and output provisional labels associated with each data element in the first data set.

The model training system can generate, using the one or more machine-learned encoder models and the plurality of machine-learned decoder models, a plurality of provisional labels for the unlabeled data elements, such that each unlabeled data element has an associated provisional label. In some examples, the modeling training system can aggregate, for a particular data element included in the first data set, a plurality of distinct provisional labels generated by a plurality of machine-learned decoder models into an aggregated provisional label. In some examples, the aggregated provisional label includes one or more potential labels, each potential label having an associated likelihood value.

The model training system can train one or more student models using the unlabeled data elements and their associated provisional labels. In some examples, a number of parameters associated with the machine-learned encoder models and the machine-learned encoder models exceed a number of parameters associated with the student models. For example, in some cases, the larger encoder decoder teacher models can have millions of parameters and the smaller student models can have ten thousand or fewer parameters.

In some examples, training one or more student models can include, for a respective student model in the one or more machine-learned encoder models, initializing values for a plurality of parameters associated with the respective student model and generating, using the respective machine-learned encoder model, labels for a plurality of data elements in the first data set. The model training system can compare the generated labels with the aggregated provisional labels generated by the plurality of machine-learned decoder models for the plurality of data elements in the first data set.

The model training system can update the values for the plurality of parameters associated with the respective student model based on the comparison between the generated labels and the aggregated provisional labels generated by the plurality of machine-learned decoder models for the plurality of data elements in the first data set. In some examples, the modeling training system can remove the labels from the labeled elements in the second data set and use those data elements to train the student models. Once the student models are trained the student models can be deployed onto one or more embedded computing devices.

Embodiments of the disclosed technology provide a number of technical effects and benefits, particularly in the area of machine-learned models for embedded computing systems. In particular, embodiments of the disclosed technology provide improved techniques for efficient training of tiny machine-learned models using large unlabeled data sets. For example, one particular technical problem that arises in the area of embedded devices that process raw input is the reduced accuracy of the models used due to the constrains of the embedded environment both in terms of computer data storage space for large models and the lack of sufficient processing power. As a result of these constraints, to achieve classification accuracy needed in such systems cannot be achieved with traditional training models. To overcome these limitations, the disclosed technology using a specific arrangement of training techniques and model construction to improve accuracy.

Specifically, the disclosed technology uses a teacher model that has been trained to generate provisional labels from raw unlabeled data elements, to provide provisional labels for use during the training process of the smaller student models. The large number of provisionally labelled data elements allows for the smaller model to achieve much higher accuracy in classifying raw sensor data than could be achieved with traditional training models.

Thus, the disclosed technology enables the tiny models to be trained without the cost and time of manually labeling all the data elements in the large data set. More specifically, once trained, the tiny machine-learned models perform classification tasks with accuracy similar to the much larger teacher models with significantly fewer storage requirements and processing power requirements. For example, if the teacher models operate at 500 million instructions per second (MIPS) and use 5 watts per hour. This amount of processing power and electricity use is not available in embedded computing devices. With the disclosed technology, similar accuracy can be achieved with only 0.2 million instructions per second (MIPS) and consume only 0.5 milliwatts per hour. As such, the described technology results in significant savings in the cost of processing power, cost of data storage systems, and reduced time.

The disclosed technology can enable good accuracy on student models for use in embedded devices. Embedded devices have limited processing power and memory, thus the disclosed method for training students increases the accuracy that the embedded system can achieve for tasks with limited labeled examples. However, as additional resources are made available, the disclosed method can improve further. Thus, as additional processing power, memory, and labeled examples are made available the disclosed process provides improved performance. Thus, the disclosed methods and systems are not limited only to embedded systems with limited resources. Instead, it can be used in any context.

With reference now to the figures, example aspects of the present disclosure will be discussed in greater detail.

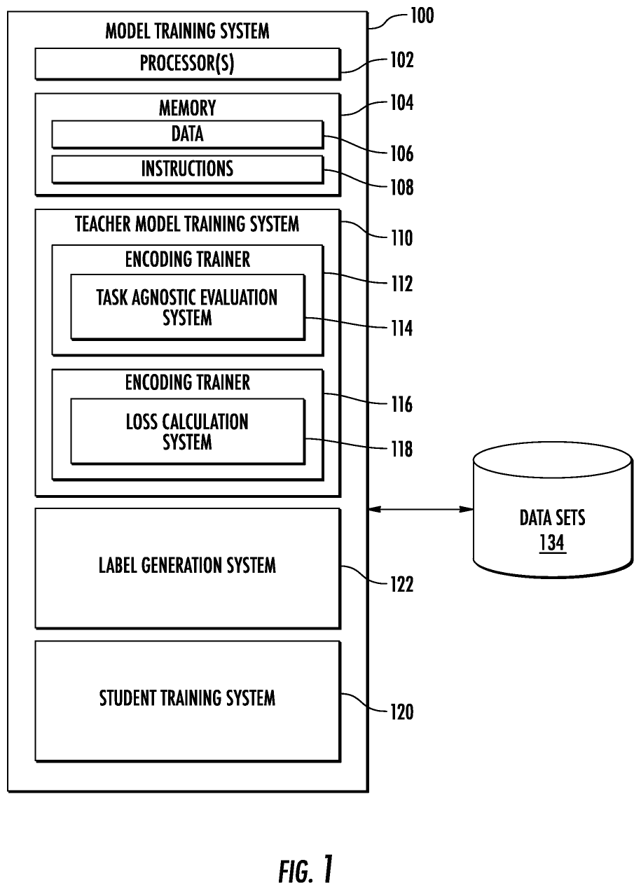

FIG. 1 illustrates an example computing environment including a model training system 100 in accordance with example embodiments of the present disclosure. In this example, the model training system 100 can include one or more processors 102, memory 104, a teacher model training system 110, a student training system 120, and one or more data sets 134.

In more detail, the one or more processors 102 can be any suitable processing device that can be embedded in the form factor of a model training system 100. For example, such a processor can include one or more of: one or more processor cores, a microprocessor, an ASIC, a FPGA, a controller, a microcontroller, etc. The one or more processors can be one processor or a plurality of processors that are operatively connected. The memory 104 can include one or more non-transitory computer-readable storage mediums, such as RAM, ROM, EEPROM, EPROM, flash memory devices, etc., and combinations thereof.

In particular, in some devices, memory 104 can store instructions 108 for implementing the teacher model training system 110 and/or the student training system 120. The model training system can implement the teacher model training system 110 and the student training system 120 to execute aspects of the present disclosure, including training a teacher model and a tiny student model to efficiently perform a task on an embedded system.

It will be appreciated that the term “system” can refer to specialized hardware, computer logic that executes on a more general processor, or some combination thereof. Thus, a system can be implemented in hardware, application specific circuits, firmware and/or software controlling a general-purpose processor. In one embodiment, the system can be implemented as program code files stored on the storage device, loaded into memory, and executed by a processor or can be provided from computer program products, for example computer executable instructions, that are stored in a tangible computer-readable storage medium such as RAM, hard disk or optical or magnetic media.

Memory 104 can also include data 106 that can be retrieved, manipulated, created, or stored by the one or more processor(s) 102. In some example embodiments, such data can be accessed and used as input to the teacher model training system 110 or the student training system 120. In some examples, the memory 104 can include data used to perform one or more processes and instructions that describe how those processes can be performed.

In some examples, the model training system 100 can include a teacher model training system 110. The teacher model training system 110 can include an encoding trainer 112 and decoding trainer 116. The teacher model training system 110 can train a plurality of two-part teacher models. The first part being a large encoding model that can be pre-trained in a task agnostic manner. The second part is a decoder that is paired with one of the encoders and then trained to perform a specific task. The encoding model can be trained using a large amount of unlabeled data in an unsupervised training technique. The decoder, once paired with one of the already trained encoders, can be trained using a smaller amount of labeled data using a supervised training technique.

The encoding trainer 112 can train one or more neural networks to perform an encoding task. The encoder model can be trained in a task agnostic matter. Thus, to train the encoder model, the encoding trainer 112 can initiate one or more encoder models with initial parameter values (e.g., weights). The encoding trainer 112 can access data from the data set database 134. The data set database 134 can include a large amount of unlabeled data elements and a smaller amount of labeled data elements. The encoding trainer 112 can access the large amount of unlabeled data elements. Because the data elements do not have labels and are not associated with a specific task, the model training system can be trained in an unsupervised way without a specific task that can be used to evaluate the accuracy of the model. Instead, a task agnostic algorithm (e.g., a clustering algorithm) can be used to evaluate the encoded data output by the encoder model while training. To do so, the encoding trainer 112 can use the unlabeled data set as input to the one or more encoded training models. The one or more encoder training models can output encoded data (or embeddings) associated with each data element.

The encoding trainer 112 can, for each portion of the data sets, evaluate the accuracy of the encoded data using one or more unsupervised training algorithms implemented by the task agnostic evaluation system 114. For example, an algorithm such as a clustering algorithm can allow the task agnostic evaluation system 114 to evaluate the encoded versions of data produced by the one or more encoder models and adjust the parameter values in response to that evaluation.

In one example, if the dataset includes a plurality of images without a particular task to accomplish, the encoded data can represent information indicating that one grouping of images that are similar. In some examples, a clustering algorithm can be used to group data elements used as input to the encoder model into one or more clusters. The grouping can then be evaluated using a cluster evaluation technique implemented by the task agnostic evaluation system 114 and the parameter values can be adjusted based on that evaluation. The grouping can be evaluated using a clustering algorithm and the parameters of a model can be adjusted such that the model more accurately groups images that are similar.

Once the task agnostic evaluation system 114 determines that the encoded data produced by the one or more encoding models meet a particular threshold of accuracy, the encoding trainer 112 can determine that no further training of the one or more encoding models is necessary. In some examples, the encoding trainer 112 can train one or more encoding models in a task agnostic manner and use the trained encoding models to generate teacher models for a plurality of specific tasks without having to train new encoding models.

In some examples, once one or more encoding models have been trained by the encoding trainer 112, the teacher model training system 110 can use the decoding trainer 116 to train one or more decoding models. Each decoder model can take the encoded data produced by the one or more encoded models as input and output one or more labels or classifications associated with a particular data element used as input to the encoder model. The decoding trainer 116 can initialize a plurality of decoding models (e.g., five decoding models). Once the decoders are initialized (e.g., initial values are associated with their parameters), the model training system can access the second data set of labeled data from the data sets 134. As noted above, the labeled data can be labeled in accordance with performing a particular task.

Each decoder model can be paired, by the decoding trainer 116, with a particular encoder model to form an encoder decoder teacher model. If only one encoder model is trained, the decoding trainer 116 can pair each iteration of the decoder model with a copy of the same trained encoder model. However, if a plurality of distinct encoder models were trained, each of the plurality of distinct encoder models can be paired with a particular decoder model.

To train the decoder models, the decoding trainer 116 can input data elements associated with the label data to the encoder model associated with a particular decoder model. The encoder model can generate associated encoded data for a respective labeled data element. The decoding trainer can use the encoded data for the respective labeled data element as input to the decoder model. The decoder model can produce a provisional label for the respective labeled data element as output. For example, the provisional label can serve as a soft label that associate the respective labeled data element with one or more categories or types with an associated confidence value. The loss calculation system can compare the provisional labels for one or more labeled data elements to the predetermined label (e.g., the “hard label”). The difference between the provisional labels and the predetermined labels for one or more labeled data elements can be used to calculate a cross entropy teacher loss data value by the loss calculation system 118. The parameters of both the decoder model and its associated encoder model can be tuned (or adjusted) by the decoding trainer 116 to minimize the categorical cross entropy teacher loss as shown below:

$${L}^{{T}_{k}} = - {\sum }_{i}^{\vert \hat{D} \vert} {\sum }_{j}^{\vert y \vert} {y}_{j} log {P}^{{T}_{k}} ( {y}_{j} \vert {x}_{i} )$$

where P^{T}^{ₖ}(yⱼ|xᵢ) is the k′th teacher's probability estimate of the j′th class, given the i′th data example:

$${P}^{{T}_{k}} ( {y}_{j} \vert {x}_{i} ) = \frac{exp ( {f}_{k} ( {g}_{k} ( {x}_{i} ) ) [ {y}_{j} ] / τ )}{{\sum }_{n}^{\vert y \vert} exp ( {f}_{k} ( {g}_{k} ( {x}_{i} ) ) [ {y}_{n} ] / τ )}$$

Here τ represents the temperature parameter commonly used in distillation, where higher values of τ produce a “softer” probability distribution over the respective classes (also called categories or labels).

Thus, the output of a pair of encoding models and decoding models (e.g., together referred to as an encoder decoder teacher model) can include, for each data element, one or more provisional labels.

In some examples, once encoding trainer 112 has trained one or more encoding models and the decoding trainer 116 has trained a plurality of decoding models, the teacher model training system 110 can pair each decoding model with an encoding model to create a plurality of machine-learned encoding decoding teacher models. It should be noted that because the encoding model is trained agnostically, the teacher model training system 110 can, if directed to, train only a single encoding model that is paired with a plurality of different decoding models for a given task. Similarly, the single encoding model can also be used for a plurality of different tasks. Alternatively, the teacher model training system 110 can train a plurality of different encoding models.

The label generation system 122 can access the plurality of machine-learned encoding decoding teacher models. The label generation system 122 can, for each of the plurality of machine-learned encoding decoding teacher models, access a plurality of unlabeled data elements in the data sets database 134. Each machine-learned encoding decoding teacher model can generate a provision label (e.g., a soft label) for each unlabeled data element in the plurality of data elements. As noted above, the provisional label for a particular data element can include one or more labels or categories. In some examples, the one or more labels can each have an associated confidence or weight representing the likelihood that the data element should have that label. For example, if the data element is an image and the labels represent animals that appear in the image, a particular image could have the labels lion and jaguar with lion having a confidence value of 70% and jaguar having a confidence value of 30%.

Every unlabeled data element in the first data set can be associated with one or more provisional labels outputted by the plurality of encoder decoder teacher models. Thus, if there are five total machine-learned encoder decoder teacher models, each one will produce its own provisional labels, resulting in five different provisional labels.

In some examples, the provisional labels generated by each of the plurality of encoder decoder teacher models can be combined by the label generation system 122 together into an aggregated provisional label. An aggregated provisional label can represent an average estimation of the correct label for a particular data element. In another example, the aggregated provisional label can include all information generated by each of the encoder decoder teacher models for use when training the student models.

The student training system 120 can access the plurality of data elements and their associated aggregated provisional labels. The student training system 120 can then initialize one or more student models. As noted above, the student models can include significantly fewer parameters (e.g., weights of nodes and other data used to describe and define the model) than either the encoder models or the decoder models. For example, the encoder models can include a very large set of parameters (e.g., over 1,000,000 parameters). In contrast, the student models can include orders of magnitude fewer parameters (e.g., less than 25,000).

To train the one or more student models, the student training system 120 can use unlabeled data elements from the data set database 134 as input to the one or more student models. The one or more student models can then generate labels for each unlabeled data element as output. The parameters (e.g., weights) of the one or more student models can be adjusted by the student training system 120 based on a comparison between the label generated by the student model and the provisional labels (or aggregated provisional labels) generated by the encoding decoding teacher models.

For example, the model training system can measure the student ensemble loss over the full complement of the training data D such that the loss can be represented as:

$${L}^{TS} = - {\sum }_{i}^{\vert D \vert} {\sum }_{j}^{\vert y \vert} log {P}^{S} ( {y}_{j} \vert {x}_{i} ) \frac{1}{K} {\sum }_{k}^{K} {P}^{{T}_{k}} ( {y}_{j} \vert {x}_{i} )$$

wherein P^{T}^{_{K}}(yⱼ|xᵢ) is the provisional label emitted by the K′th teacher model in the plurality of teacher models and P^{S}(yⱼ|xᵢ) is the student's estimation of the jth label probability for the ith data element.

$${P}^{S} ( {y}_{j} \vert {x}_{i} ) = \frac{exp ( {f}_{S} ( {x}_{i} ) [ {y}_{j} ] / τ )}{{\sum }_{n = 1}^{\vert y \vert} exp ( {f}_{S} ( {x}_{i} ) [ {y}_{n} ] / τ )}$$

where f_{S}(xᵢ) is the prediction from the student.

Once the student models have been trained using the provisionally labeled data, the student models can classify new data elements received with significantly fewer parameters. The provisional labels provided by the plurality of encoder decoder teacher models enable the student models to be trained to accurately classify unlabeled data elements with a fraction of the resources used by the encoder decoder teacher models.

Once the student models have been trained using the provisionally labeled data by the student training system 120, the student models can classify new data elements received with significantly fewer parameters. The provisional labels provided by the plurality of encoder decoder teacher models enable the student models to be trained to accurately classify unlabeled data elements with a fraction of the resources used by the encoder decoder teacher models.

The data sets database 134 can include a plurality of data elements. For example, the data elements can include images, audio files, sensor data, and so on. In some examples, the data elements can be generated from a time series of sensor data divided into equal periods of time. In some examples, the data elements in the data sets database 134 are unlabeled. In some examples, the data elements can have predetermined associated labels. The predetermined associated labels can be generated by humans. In addition, the predetermined associated labels can be associated with a particular task. For example, a given task may include identifying words from raw audio data and the labels may indicate the word included in the associated portion of raw audio data as determined by a human labeler. In some examples, the predetermined human labels can be referred to as hard labels.

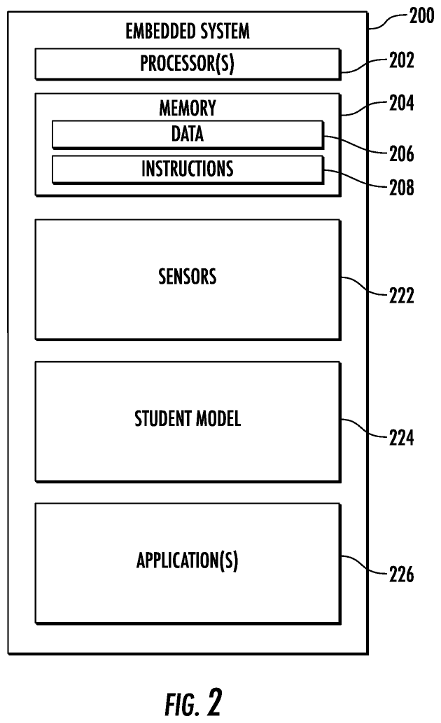

FIG. 2 illustrates an example computing environment including an embedded system 200 in accordance with example embodiments of the present disclosure. In this example, the embedded system 200 can include one or more processors 202, memory 204, one or more sensors 222, a student model 224, and one or more application(s) 226.

In more detail, the one or more processors 202 can be any suitable processing device. For example, such a processor can include one or more of: one or more processor cores, a microprocessor, an ASIC, a FPGA, a controller, a microcontroller, etc. The one or more processors can be one processor or a plurality of processors that are operatively connected. The memory 204 can include one or more non-transitory computer-readable storage mediums, such as RAM, ROM, EEPROM, EPROM, flash memory devices, etc., and combinations thereof.

In particular, in some devices, memory 204 can store instructions 208 for implementing the student model 224 and/or the one or more applications 226. Memory 204 can also include data 206 that can be retrieved, manipulated, created, or stored by the one or more processor(s) 202. In some example embodiments, such data can be accessed and used as input to the student model 224 and/or the one or more applications 226. In some examples, the memory 204 can include data used to perform one or more processes and instructions that describe how those processes can be performed.

In some examples, the embedded device 200 can also include sensors 222, student model 224, and one or more application(s) 226. The one or more sensors 222 can include, but are not limited to: audio sensors, pressure sensors, light sensors, temperature sensors, haptic sensors, a gyroscope, an accelerometer, touch sensors, and so on. The one or more sensors 222 can capture data and provide it to the student model 224.

As discussed above, the student model 224 can be trained to perform a specific, such as generating a label or classification based on raw data elements (e.g., the data captured by the one or more sensors 222). The student model 224 is relatively small for a machine-learned model and can have 10,000 parameters or fewer while still accurately performing the task for which it has been trained. The student model 224 can provide the sensor data with the appropriate labels to one or more applications 226.

The applications 226 can be associated with one or more functions provided by the embedded system 200. For example, the embedded system 200 can be included in a wearable computing device (e.g., integrated into a jacket) and can include an audio sensor. An application 226 can be associated with waking up the embedded computing device when a particular word or phrase is spoken by the user. The sensors 222 can record the raw audio and the student model 224 can label portions of the recorded raw audio according to whether the portions include the particular word or phrase. If so, the application 226 can initiate waking up the wearable computing device. Similarly, if the embedded system 200 is included in a piece of apparel (e.g., a jacket) that has touch input capability for controlling an associated user computing device (e.g., a smartphone), the sensors 222 (e.g., touch sensors) can detect data associated with the user touch input. The student models 224 can label each the detected touch input to determine whether it is one of a plurality of predetermined touch inputs. The labeled touch data can be used by the applications 226 to generate commands for the user device.

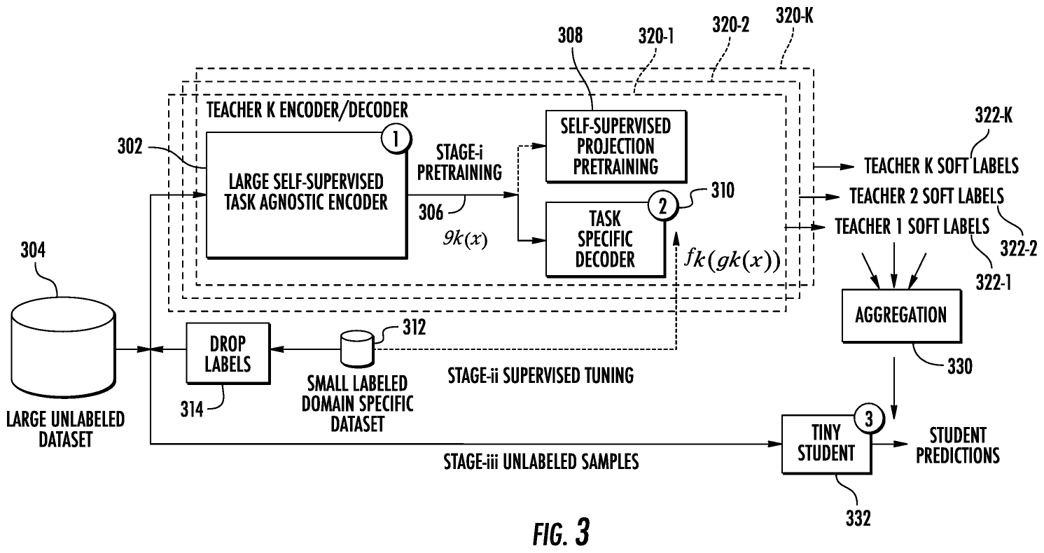

FIG. 3 illustrates an example computing environment including a model training system in accordance with example embodiments of the present disclosure. The model training system (e.g., model training system 100 in FIG. 3) can initiate one or more large task agnostic encoder models 302 with initial parameter values (e.g., weights). In this context a large model can include millions of parameters. The model training system 100 can train 306 the large task agnostic encoder models 302 using a large unlabeled data set 304 containing a plurality of data elements as input to the one or more large task agnostic encoder models 302. The one or more large task agnostic encoder models 302 can be trained to output encoded versions of each data element.

As part of the training process, the model training system 100 can evaluate the accuracy of the encoded data produced by the large task agnostic encoder models 302 using one or more self-supervised projection training algorithms 308. For example, an algorithm such as a clustering algorithm can allow the model training system 100 to evaluate the encoded versions of data produced by the one or more large task agnostic encoder models 302 and adjust the parameter values of the one or more large task agnostic encoder models 302 in response to that evaluation. In some examples, the encoded data can be embeddings that serve to, among other things, group the data elements used as input to the encoder model into one or more clusters. The clusters can then be evaluated using a cluster evaluation technique and the parameter values can be adjusted based on that evaluation.

In some examples, a second data set of labeled domain specific data elements can have predetermined labels associated with each data element. These labels may be added by human reviewers prior to the training process and can represent classifications or labels associated with a particular task.

Once the one or more encoder models have been trained to a predetermined threshold of accuracy, the model training system 100 can initialize a plurality of decoder models 310. To train the decoder models 310, the model training system 100 can use trained large task agnostic encoder models 302 to generate encoded data based on the second data set of labeled specific data elements 312. Each decoder model 310 can take as the encoded data as input and output one or more labels or classifications associated with a particular data element used as input to the large task agnostic encoder models 302. Once the encoders are initialized (e.g., initial values are associated with their parameters), the model training system 100 can access the second data set of labeled data. As noted above, the labeled data can be labeled in accordance with performing a particular task or in a task-specific domain.

Each decoder model 310 can be paired with a particular encoder model to form an encoder decoder teacher model 320. The resulting plurality of encoder decoder teacher models (320-1 to 320-K) can use unlabeled data elements from the large unlabeled dataset 304 as input and produce provisional labels (322-1 to 322-K) for the respective data element as output.

To train the decoder models 310, data elements associated with the labeled data are stripped of their labels 314 and used as input to the encoder decoder teacher model (320-1 to 320-K) and the decoder 310 can produce a provisional label. That provisional label can be compared to the predetermined category or label and cross entropy teacher loss can be calculated. The parameters of both the decoder model 310 and its large task agnostic encoder model 302 can be tuned (or adjusted) to minimize the categorical cross entropy teacher loss (see formula above).

Thus, the output of the encoder decoder teacher models (320-1 to 320-K) can include, for each data element, one or more labels (322-1 to 322-K). In some examples, the one or more labels (322-1 to 322-K) can each have an associated confidence or weight representing the likelihood that the data element should have that label. Every unlabeled data element in the first data set can be associated with one or more provisional labels outputted by the plurality of encoder decoder teacher models (320-1 to 320-K). In addition, if there are five total encoder decoder teacher models (320-1 to 320-K), each one will produce its own provisional labels (322-1 to 322-K).

In some examples, the provisional labels generated by each of the plurality of encoder decoder teacher models (320-1 to 320-K) can be combined together into an aggregated provisional label 330. The aggregated provisional label 330 can represent an average estimation of the correct label for a particular data element. In another example, aggregated provisional label 330 can include all information generated by each of the encoder decoder teacher models (320-1 to 320-K) for use when training the student models.

The model training system 100 can then initialize one or more student models 332. As noted above, the student models 322 can include significantly fewer parameters (e.g., weights of nodes and other data used to describe and define the model) than either the large task agnostic encoder models 302 or the decoder models 310. For example, the large task agnostic encoder models 302 can include a very large set of parameters (e.g., over 1,000,000 parameters). In contrast, the student models 332 can include orders of magnitude fewer parameters (e.g., less than 10000).

While being trained the student models 332 can receive data elements from the first data set as input and generate labels as output. The parameters (e.g., weights) of the one or more student models 332 can be adjusted based on a comparison between the label generated by the student model 332 and the provisional labels (or aggregated provisional label) generated by the encoding decoding teacher models (320-1 to 320-K).

For example, the model training system 100 can measure the student ensemble loss over the full complement of the training data D. Once the student models 332 have been trained using the provisionally labeled data, the student models 332 can classify new data elements received with significantly fewer parameters. The provisional labels provided by the plurality of encoder decoder teacher models (320-1 to 320-K) enable the student models 332 to be trained to accurately classify unlabeled data elements with a fraction of the resources used by the encoder decoder teacher models.

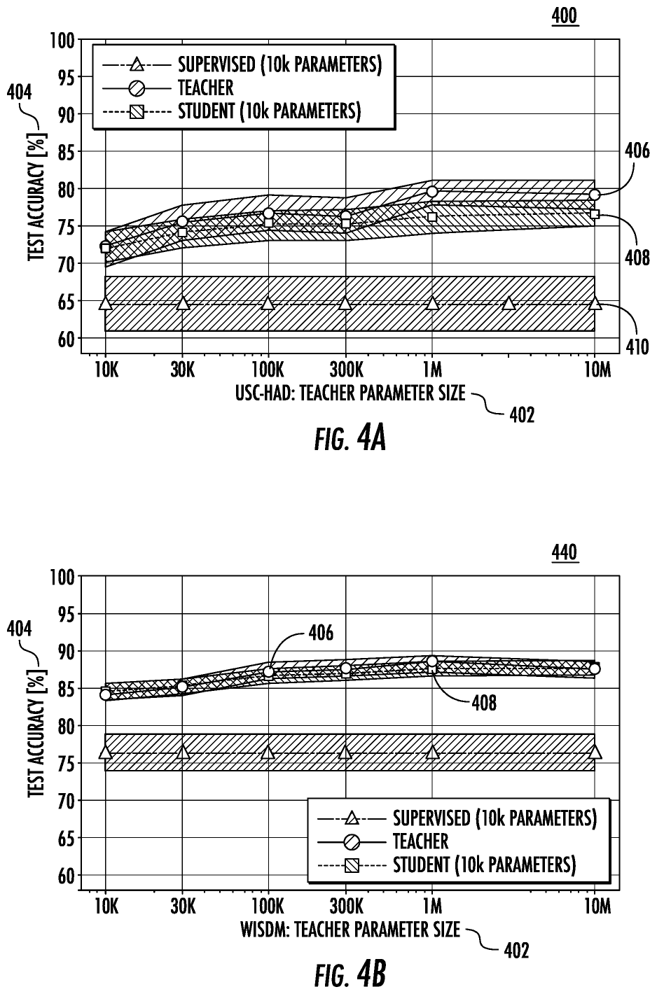

FIG. 4A is a graph 400 depicting the accuracy of machine-learned models with respect to the number of parameters used in a teacher model 320 in accordance with example embodiments of the present disclosure. The graph 400 plots the number of parameters 402 in the teacher model 320 along the x-axis and the accuracy of models (a semi-supervised teacher model 406, a student model 408 with 10K parameters, and a supervised model with 10K 410) 404 using the USC-HAD dataset. As can be seen the semi-supervised teacher model 406 and the student model 408 have similar performance that increases with the number of parameters associated with the teacher model 320 (even though the student model 408 has significantly fewer parameters) and both significantly outperform the traditionally trained supervised model 410. Note that there is a small drop in accuracy shown as the number of parameters approaches 10 million but this is primarily due to the limited dataset sizes. Thus, this graph 400) demonstrates that the training method disclosed here results in significant improvements in accuracy for student models 408 trained in this way over similar sized models 410 trained using a traditional supervised training method.

FIG. 4B is a graph 440 depicting the accuracy of machine-learned models with respect to the number of parameters used in a teacher model 320 in accordance with example embodiments of the present disclosure. Similar to FIG. 4A, graph 440 plots the number of parameters 442 in the teacher model 320 along the x-axis and the accuracy of models (a semi-supervised teacher model 406, a student model 408 with 10K parameters, and a supervised model with 10K 410) 404 along the y-axis but does so with respect to the WISDM dataset. As can be seen the semi-supervised teacher model 406 and the student model 408 have similar performance (even though the student model 408 has significantly fewer parameters) that generally increases as the number of parameters in the teacher model 320 increases and both significantly outperform the traditionally trained supervised model 410. Note that as with FIG. 4A there is a drop in accuracy as the number of parameters approaches 10 million but this is primarily due to the limited dataset sizes. Thus, this graph 440 also demonstrates that the training method disclosed here results in significant improvements in accuracy for student models 408 trained in this way over similar sized models 410 trained using a traditional supervised training method.

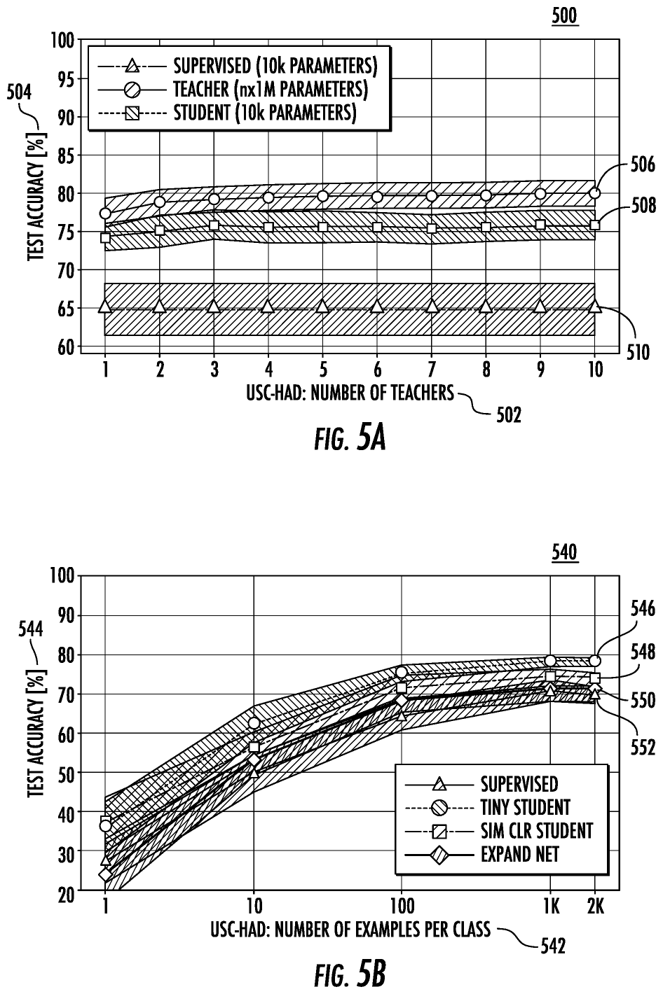

FIG. 5A is a graph depicting the accuracy of student machine-learned models based on the number of teacher machine-learned models in accordance with example embodiments of the present disclosure. The graph 500 plots the number of teacher models 502 used in training the student models along the x-axis and the accuracy of models 504 (a semi-supervised teacher model 506, a student model 508 with 10K parameters, and a supervised model with 10K 510) along the y-axis using the USC-HAD dataset. As can be seen, the graph 500 shows that the semi-supervised teacher model 506 and the student model 508 have similar performance that increases with the number of teachers and both significantly outperform the traditionally trained supervised model 510. As such, this graph 500 shows evidence that training student models using teacher models 320 can result in significant accuracy improvements over traditionally trained supervised models even with a small number of training examples. Additionally, as the number of teachers increases (and thus the diversity of teachers) the accuracy of the student models and the teacher models increases.

FIG. 5B is a graph 540 depicting the test accuracy in student machine-learned models based on the number of examples (e.g., labeled data elements) for each class or category in accordance with example embodiments of the present disclosure. Graph 540 plots the number of examples (e.g., labeled data elements) for each class or category 542 used in training the student models along the x-axis and the test accuracy of the models (a traditionally supervised model 552, a student model 546, simCLR student model 548, and a ExpandNet model 550) along the y-axis 544. As can be seen, the graph 540 shows that the student model 546 achieves over 60 percent accuracy with only 10 examples per class while the other models all have less accuracy. Thus, this graph 540 shows evidence that training student models as discussed herein can result in significant improvements in accuracy even with a small number of training examples.

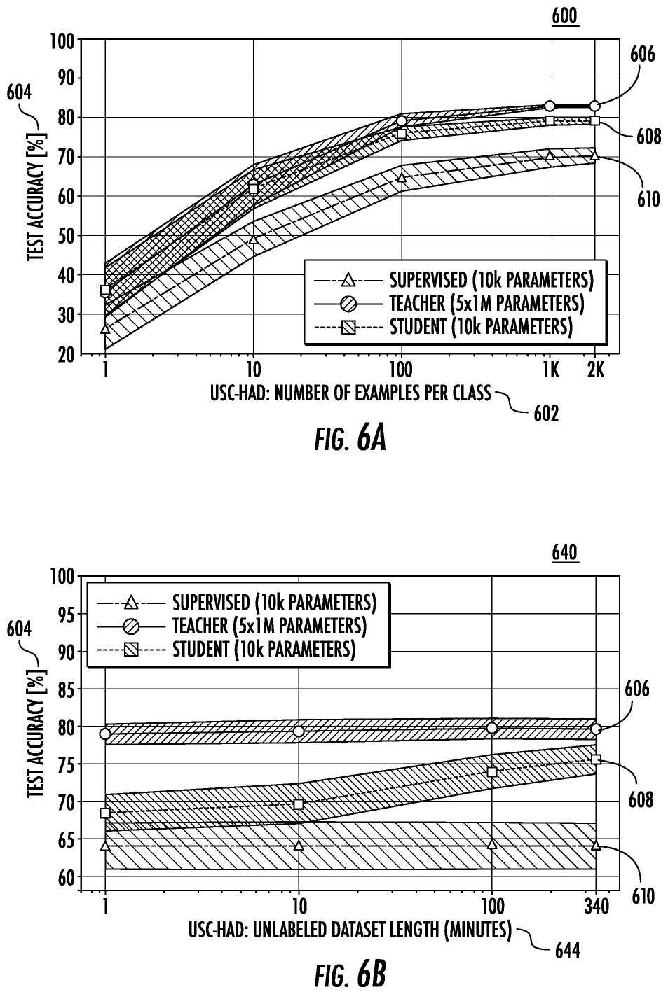

FIG. 6A is a graph 600 depicting the accuracy of machine-learned models based on the number of available examples in accordance with example embodiments of the present disclosure. The graph 600 plots the number of examples per class 602 along the x-axis and the accuracy of models (a semi-supervised teacher model 606, a student model 608 with 10K parameters 608, and a supervised model with 10K 610) 604 using the USC-HAD dataset. As can be seen the semi-supervised teacher model 606 and the student model 608 have similar performance that increases with the number of examples per class (even though the student model 608 has significantly fewer parameters) and both significantly outperform the traditionally trained supervised model 610, most clearly at lower numbers of examples per class. Thus, this graph 600 demonstrates that the training method disclosed here results in significant improvements in accuracy for student models 608 even when trained with very few examples per class.

FIG. 6B is a graph 640 depicting the accuracy of machine-learned models based on the length of the unlabeled dataset in accordance with example embodiments of the present disclosure. Similar to FIG. 6A, graph 640 plots the length of the unlabeled dataset in minutes along the x-axis 644 and the accuracy of models (a semi-supervised teacher model 606, a student model with 10K parameters 608, and a supervised model with 10K 610) 604 along the y-axis. As can be seen the semi-supervised teacher model 606 and the student model 608 have similar performance (even though the student model 608 has significantly fewer parameters) that generally increases as the length of the dataset increases and both significantly outperform the traditionally trained supervised model 610. Thus, this graph 640 shows evidence that the training method disclosed herein results in significant improvements in accuracy for student models 608 trained in this way over similar sized models 610 trained using a traditional supervised training method.

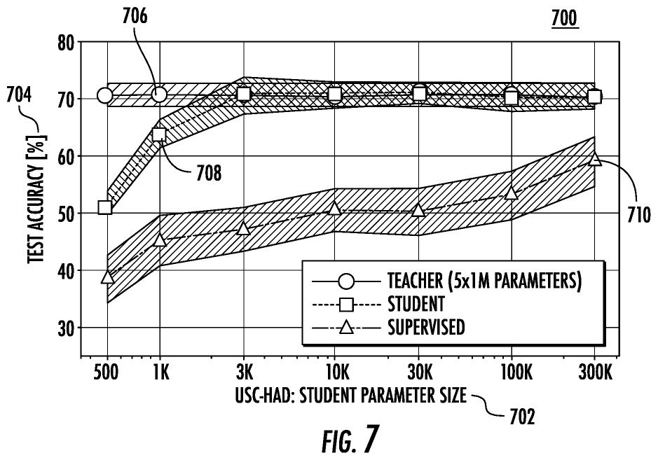

FIG. 7 is a graph depicting the accuracy of machine-learned models based on the number of parameters in the student models in accordance with example embodiments of the present disclosure. The graph 700 plots the number of parameters in the student model 702 along the x-axis and the accuracy of models (a semi-supervised teacher model 706 with 1 million parameters, a student model 710 trained by the teacher model 320, and a model trained with traditional supervised training method) 704 using the USC-HAD dataset. As can be seen the teacher model(s) 706 and the student model 708 have similar performance once the student model has more than 1000 parameters and both significantly outperform the traditionally trained supervised model 710. Thus, this graph 700 demonstrates that the training method disclosed herein results in significant improvements in accuracy for student models 708 even when using very few parameters (e.g., less than 10000).

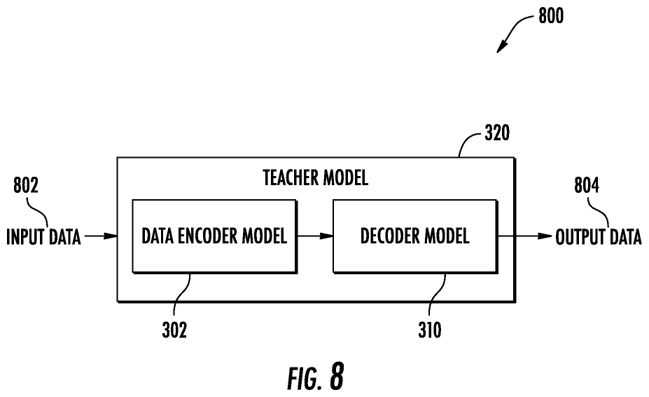

FIG. 8 depicts a block diagram 800 of an example teacher machine-learned model 320 according to example embodiments of the present disclosure. A machine-learned document teacher model 320 can include a data encoder model (e.g., large task agnostic encoder model 302 in FIG. 3) and a decoder model 310. The machine-learned teacher model 302 can be trained to receive a set of input data 802. The input data 802 can include a plurality of unlabeled data elements and a smaller set of data elements labeled in accordance with a particular task. The data elements used as input data 802 can include any data captured or received by a computing system including images, audio, touch sensor data, motion data (e.g., from a gyroscope or accelerometer), pressure sensed data, and so on. In response to receiving input data 802, the teacher model 320 provides output data 804. The output data can include provisional labels for each data element used as input data 802.

In some examples, the data encoder model 302 can generate embedded versions of each input data element. The embedded versions can represent one or more features in the data element and can thus have the effect of grouping data elements with similar features together (e.g., in that similar features will be found in data elements and can be considered grouped). Thus, the data encoder model 302 can represent the raw data elements in an embedded format that can easily be used as input to the decoder model, with important features already identified and the data elements at least partially grouped based on determined features. In some examples, the machine-learned teacher model 320 can otherwise include various machine-learned models such as neural networks (e.g., deep neural networks), other types of machine-learned models, including non-linear models and/or linear models, or binary classifiers. Neural networks can include feed-forward neural networks, recurrent neural networks (e.g., long short-term memory recurrent neural networks), convolutional neural networks, or other forms of neural networks.

The decoder model 310 can receive, from the data encoder model 302, embedded data representing each of a plurality of data elements included in the input data 802. The decoder model 310 can then generate, for each element, a label associated with a specific task. In some examples, the machine-learned decoder model can otherwise include various machine-learned models such as neural networks (e.g., deep neural networks), binary classifiers, or other types of machine-learned models, including non-linear models and/or linear models. Neural networks can include feed-forward neural networks, recurrent neural networks (e.g., long short-term memory recurrent neural networks), convolutional neural networks or other forms of neural networks.

Although the machine-learned data encoder model 302 and the decoder model 310 are described as using particular techniques above, a variety of training techniques can be used to train them. Specifically, the encoder model 302 can be trained using one of a plurality of unsupervised training techniques. The decoder model 310 can be trained using a supervised training technique, such as, for example, backward propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over several training iterations. In some implementations, performing backward propagation of errors can include performing truncated backpropagation through time. Generalization techniques (e.g., weight decays, dropouts, etc.) can be performed to improve the generalization capability of the models being trained.

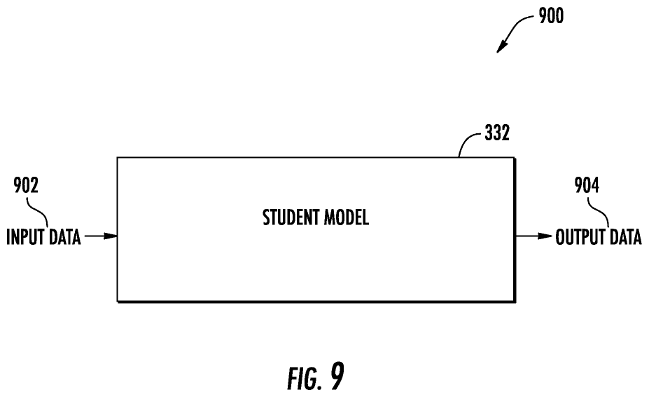

FIG. 9 depicts a block diagram 900 of an example student machine-learned model 906 according to example embodiments of the present disclosure. A machine-learned document student model 906 can include a data encoder model 302 and a decoder model 310. The machine-learned teacher model 302 can be trained to receive a set of input data 902. The input data 902 can include a plurality of unlabeled data elements. The data elements used as input data 902 can include any data captured or received by a computing system including images, audio, touch sensor data, motion data (e.g., from a gyroscope or accelerometer), pressure sensed data, and so on. In response to receiving input data 902, the student model 332 provides output data 904. The output data can include labels for each data element used as input data 902.

In some examples, the machine-learned student model can otherwise include various machine-learned models such as neural networks (e.g., deep neural networks), binary classifiers, or other types of machine-learned models, including non-linear models and/or linear models. Neural networks can include feed-forward neural networks, recurrent neural networks (e.g., long short-term memory recurrent neural networks), convolutional neural networks or other forms of neural networks.

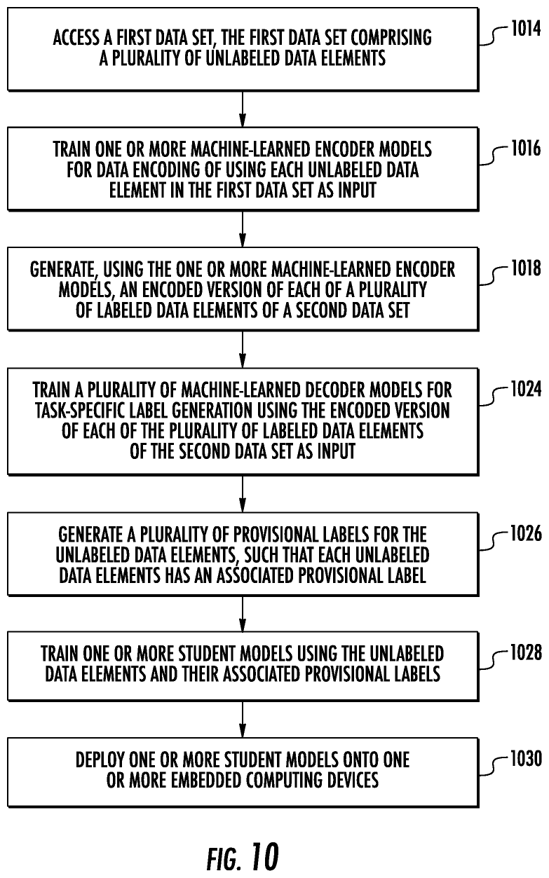

FIG. 10 is a flowchart depicting an example process of training an efficient computing-learned model for use on an embedded computing device in accordance with example embodiments of the present disclosure. One or more portion(s) of the method can be implemented by one or more computing devices such as, for example, the computing devices described herein. Moreover, one or more portion(s) of the method can be implemented as an algorithm on the hardware components of the device(s) described herein. FIG. 10 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. The method can be implemented by one or more computing devices, such as one or more of the computing devices depicted in FIGS. 1-3.

A model training system (e.g., model training system 100 in FIG. 1) can include memory and one or more processors to execute instructions stored in the memory. The model training system 100 can access, at 1014, a first data set, the first data set comprising a plurality of unlabeled data elements. Date elements can be files, data structures, sequential time series data captured by sensors and sub-divided into a plurality of time periods, or any other format for storing digital data.

The model training system 100 can, at 1016, train one or more machine-learned encoder models to generate an encoded version of each data element in the first data set. Each model described herein (e.g. encoder models, decoder models, teacher models, and student models) can have an associated plurality of parameters. Used generally, the parameters associated with a model include the data that describes the characteristics of the model, including but not limited to the weights assigned to each node a neural network (e.g. for models that use a neural network).

In some examples, the one or more machine-learned encoder models can be trained to be task agnostic. The machine-learned encoder model can be trained using an unsupervised training technique. In this way, the one or more machine-learned encoder models can be used for multiple different tasks. More specifically, once a task-agnostic encoder model has been trained, it can be replicated for use with a plurality of different task specific decoders, significantly reducing the amount of time and power needed to train task specific models.

Training the one or more machine-learned encoder models to generate an encoded version of each data element in the first data set can include, for a respective machine-learned encoder model in the one or more machine-learned encoder models, initializing values for a plurality of parameters associated with the respective machine-learned encoder model. In some examples, the initial values are randomly chosen (or pseudo randomly). In other examples, the initial values can be based on a pre-existing model (e.g., a model developed for a similar task in the past).

The model training system 100 can, at 1018, generate, using the respective machine-learned encoder model, encoded data for a plurality of data elements in the first data set. The modeling training system 100 can evaluate the encoded data using a task-agnostic algorithm. In some examples, the task-agnostic algorithm is a clustering algorithm that determines whether the encoded data generated by the one or more machine-learned encoder model are grouped appropriately. In some examples, a specific algorithm such as a clustering algorithm case be used. For example, clustering methods can include one or more from hierarchical clustering, k-means clustering, probabilistic modeling methods, the density-based spatial clustering of applications with noise (DBSCAN) method, and so on. Anomaly detection methods such as Local Outlier Factor method and the Isolation Forest method can be used. Autoencoders, Deep Belief Nets, Hebbian Learning, Generative adversarial networks, and Self-organizing maps can also be used alone or in combination to train the encoder methods using unlabeled data.

The model training system can update the values (e.g., weights) for the plurality of parameters associated with the respective machine-learned encoder model based on the evaluation of the encoded data using the task-agnostic algorithm.

The model training system 100 can access a second data set, the second data set comprising a plurality of data elements with associated predetermined labels. In some examples, the number of unlabeled data elements in the first data set (e.g., over one hundred thousand) can exceed a number of labeled data elements in the second data set (e.g., as few as ten).

The model training system 100 can, at 1018, generate, using the one or more machine-learned encoder models, an encoded version of each of a plurality of labeled data elements of a second data set, The model training system 100 can, at 1024, train a plurality of machine-learned decoder models to generate a label for a specific task using the encoded version of each of the plurality of label data elements as input. To do so, the modeling training system 100 can, for a respective machine-learned decoder model in the plurality of machine-learned encoder models, initialize values for a plurality of parameters (e.g., node weights) associated with the respective machine-learned decoder model. As noted above, the values can be randomly generated or specifically chosen.

The model training system 100 can generate, using the respective machine-learned decoder model, labels for a plurality of data elements in the second data set. The modeling training system 100 can compare the generated labels with the predetermined labels for the plurality of data elements in the second data set. For example, the modeling training system 100 can minimize the loss (e.g., representing the difference between the generated labels and the predetermined labels).

The model training system 100 can update the values for the plurality of parameters associated with the respective machine-learned decoder model based on the comparison between the generated labels and the predetermined labels. In some examples, the predetermined labels are domain specific labels associated with the specific task.

The model training system 100 can, for a respective machine-learned decoder model, combine, by the computing system, the respective machine-learned decoder model with a machine-learned encoder model into an encoder decoder teacher model. The modeling training system 100 can generate, using the encoder decoder teacher model, labels for a plurality of data elements in the second data set. The modeling training system can compare the generated labels with the predetermined labels for the plurality of data elements in the second data set. The modeling training system 100 can update parameter values associated with the respective machine-learned decoder model and the machine-learned encoder model included in the encoder decoder teacher model. The combined encoder decoder teacher model can take data elements from the first data set as input and output provisional labels associated with each data element in the first data set.

The model training system 100 can generate, at 1026, using the one or more machine-learned encoder models and the plurality machine-learned decoder models, a plurality of provisional labels for the unlabeled data elements, such that each unlabeled data elements has an associated provisional label. In some examples, the modeling training system 100 can aggregate, for a particular data element included in the first data set, a plurality of distinct provisional labels generated by a plurality of machine-learned decoder models into an aggregated provisional label. In some examples, the aggregated provisional label includes one or more potential labels, each potential label having an associated confidence value. The confidence value can represent a calculated likelihood that the associated data element should have the potential label. Thus, if a particular data element has an aggregated provisional label that includes potential label A with a confidence value of 80, potential label B with a confidence value of 15, and potential label C with a confidence value of 5, this indicates that A is the most likely label, B is the second most likely label (but much less likely than A), and C is the least likely label but is still possible.

The model training system 100 can, at 1028, train one or more student models using the unlabeled data elements and their associated provisional labels. In some examples, a number of parameters associated with the machine-learned encoder models and the machine-learned encoder models exceed a number of parameters associated with the student models. For example, in some cases the larger encoder decoder models can have millions of parameters and the smaller student models can have ten thousand or fewer parameters.

In some examples, training one or more student models can include, for a respective student model in the one or more machine-learned encoder models, initializing values for a plurality of parameters associated with the respective student model and generating, using the respective machine-learned encoder model, labels for a plurality of data elements in the first data set. The model training system 100 can compare the generated labels with the aggregated provisional labels generated by the plurality of machine-learned decoder models for the plurality of data elements in the first data set.

The model training system 100 can update the values for the plurality of parameters associated with the respective student model based on the comparison between the generated labels and the aggregated provisional labels generated by the plurality of machine-learned decoder models for the plurality of data elements in the first data set. In some examples, the modeling training system can remove the labels from the labeled elements in the second data set and use those elements to train the student models. Once the student models are trained, the student models can be deployed, at 1030, one or more student models onto one or more embedded computing devices.

The technology discussed herein refers to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

1. A computer-implemented method comprising:
accessing, by a computing system including one or more processors, a first data set, the first data set comprising a plurality of unlabeled data elements;
training, by the computing system, one or more machine-learned encoder models for data encoding using each unlabeled data element in the first data set as input;
generating, by the computing system using the one or more machine-learned encoder models, an encoded version of each of a plurality of labeled data elements of a second data set;
training, by the computing system, a plurality of machine-learned decoder models for task-specific label generation using the encoded version of each of the plurality of labeled data elements of the second data set as input;
generating, by the computing system using the one or more machine-learned encoder models and the plurality of machine-learned decoder models, a plurality of associated provisional labels for the plurality of unlabeled data elements in the first data set, such that each unlabeled data element has an associated provisional label;
training, by the computing system, one or more student models using the plurality of unlabeled data elements from the first data set and the plurality of associated provisional labels; and
deploying, by the computing system, the one or more student models onto one or more embedded computing devices.

2. The computer-implemented method of claim 1, wherein a number of the unlabeled data elements in the first data set exceeds a number of the labeled data elements in the second data set.

3. The computer-implemented method of claim 1, wherein each model has a plurality of parameters.

4. The computer-implemented method of claim 3, wherein a number of parameters associated with the machine-learned encoder models and the machine-learned encoder models exceed a number of parameters associated with the student models.

5. The computer-implemented method of claim 1, wherein the one or more machine-learned encoder models are trained to be task agnostic.

6. The computer-implemented method of claim 1, wherein training, by the computing system, one or more machine-learned encoder models for data encoding using each unlabeled data element in the first data set as input further comprises:
for a respective machine-learned encoder model in the one or more machine-learned encoder models:
initializing, by the computing system, values for a plurality of parameters associated with the respective machine-learned encoder model;
generating, by the computing system and using the respective machine-learned encoder model, encoded data for a plurality of data elements in the first data set;
evaluating, by the computing system, the encoded data using a task-agnostic algorithm; and
updating, by the computing system, the values for the plurality of parameters associated with the respective machine-learned encoder model based on the evaluation of the encoded data using the task-agnostic algorithm.

7. The computer-implemented method of claim 6, wherein the task-agnostic algorithm is a clustering algorithm.

8. The computer-implemented method of claim 1, wherein training, by the computing system, a plurality of machine-learned decoder models for task-specific label generation using the encoded version of each of the plurality of labeled data elements of the second data set as input further comprises:
for a respective machine-learned decoder model in the one or more machine-learned encoder models:
initializing, by the computing system, values for a plurality of parameters associated with the respective machine-learned decoder model;
generating, by the computing system using the respective machine-learned decoder model, labels for a plurality of data elements in the second data set;
comparing, by the computing system, the generated labels with the labels for the plurality of data elements in the second data set; and
updating, by the computing system, the values for the plurality of parameters associated with the respective machine-learned decoder model based on comparing the generated labels with the labels for the plurality of data elements in the second data set.

9. The computer-implemented method of claim 8, wherein the labels are predetermined and domain specific labels associated with a specific task.

10. The computer-implemented method of claim 1, the method further comprising:
aggregating, by the computing system for a particular data element included in the first data set, a plurality of distinct provisional labels generated by a plurality of machine-learned decoder models into an aggregated provisional label.

11. The computer-implemented method of claim 10, wherein the aggregated provisional label includes one or more potential labels, each potential label having an associated likelihood value.

12. The computer-implemented method of claim 10, wherein training, by the computing system, one or more student models using the plurality of unlabeled data elements from the first data set and the plurality of associated provisional labels further comprises:
for a respective student model in the one or more machine-learned encoder models:
initializing, by the computing system, values for a plurality of parameters associated with the respective student model;
generating, by the computing system using the respective student model, labels for a plurality of data elements in the first data set;
comparing, by the computing system, the generated labels with the aggregated provisional labels generated by the plurality of machine-learned decoder models for the plurality of data elements in the first data set; and
updating, by the computing system, the values for the plurality of parameters associated with the respective student model based on comparing the generated labels and the aggregated provisional labels generated by the plurality of machine-learned decoder models for the plurality of data elements in the first data set.

13. The computer-implemented method of claim 1, further comprising:
combining the one or more machine-learned encoder models and the plurality of machine-learned decoder models after training into a plurality of machine-learned teacher models that take data elements from the first data set as input and output provisional labels associated each data element in the first data set.

14. The computer-implemented method of claim 1, further comprising:
removing, by the computing system, labels from the plurality of labeled data elements in the second data set to generate one or more unlabeled data elements and using the one or more unlabeled data elements from the second data set to train the student models.

15. The computer-implemented method of claim 9, wherein training, by the computing system, a plurality of machine-learned decoder models for task-specific label generation using the encoded version of each of the plurality of labeled data elements of the second data set as input further comprises:
for a respective machine-learned decoder model:
combining, by the computing system, the respective machine-learned decoder model with a machine-learned encoder model into an encoder decoder teacher model;
generating, by the computing system using the encoder decoder teacher model, labels for a plurality of data elements in the second data set;
comparing, by the computing system, the generated labels with the labels for the plurality of data elements in the second data set; and
updating, by the computing system, parameter values associated with the respective machine-learned decoder model and the machine-learned encoder model included in the encoder decoder teacher model.

16. A model training computing system, comprising:
memory; and
a processor communicatively coupled to the memory, wherein the processor executes application code instructions that are stored in the memory to cause the system to:
access a first data set, the first data set comprising a plurality of unlabeled data elements;
train one or more machine-learned encoder models for data encoding of using each unlabeled data element in the first data set as input;
generate, using the one or more machine-learned encoder models, an encoded version of each of a plurality of labeled data elements of a second data set;
train a plurality of machine-learned decoder models for task-specific label generation using the encoded version of each of the plurality of labeled data elements of the second data set as input;
generate, using the one or more machine-learned encoder models and the plurality machine-learned decoder models, a plurality of associated provisional labels for the plurality of unlabeled data elements in the first data set, such that each unlabeled data element has an associated provisional label;
train one or more student models using the plurality of unlabeled data elements from the first data set and the plurality of associated provisional labels; and
deploy the one or more student models onto one or more embedded computing devices.

17. The model training computing system of claim 16, wherein a number of unlabeled data elements in the first data set exceeds a number of labeled data elements in the second data set.

18. The model training computing system of claim 16, wherein each model has a plurality of parameters.

19. The model training computing system of claim 18, wherein a number of parameters associated with the machine-learned encoder models and the machine-learned encoder models exceed a number of parameters associated with the student models.

20. An embedded computing device, comprising:
a computing storage device storing a small machine learned model;
one or more processors configured to execute the small machine-learned model to perform a designated task, said small machine-learned model being trained by:
accessing, by a model training system including one or more processors, a first data set, the first data set comprising a plurality of unlabeled data elements;
training, by the model training system, one or more machine-learned encoder models for data encoding of using each unlabeled data element in the first data set as input;
generating, by the model training system using the one or more machine-learned encoder models, an encoded version of each of a plurality of labeled data elements of a second data set;
training, by the model training system, a plurality of machine-learned decoder models for task-specific label generation using the encoded version of each of the plurality of labeled data elements of the second data set as input;
generating, by the model training system using the one or more machine-learned encoder models and the plurality machine-learned decoder models, a plurality of associated provisional labels for the plurality of unlabeled data elements in the first data set, such that each unlabeled data element has an associated provisional label;
training, by the model training system, one or more student models using the plurality of unlabeled data elements from the first data set and the plurality of associated provisional labels; and
deploying, by the model training system, the one or more student models onto one or more embedded computing devices.
